(19) United States
(12) Patent Application Publication
(10) Pub. No.: US 2017/0233650 A1
(43) Pub. Date: Aug. 17, 2017

(54) ETCH CUTTING SOLUTION FOR USE ON GLASS SUBSTRATES

(71) Applicant: THE CHEMOURS COMPANY FC, LLC, WILMINGTON, DE (US)

(72) Inventors: YOUNGJUN LU, SHANGHAI (CN); HAO-CHUN LEE, HSINCHU CITY (TW); ROBERT JEFFREY DURANTE, LANDENBERG, PA (US)

(73) Assignee: THE CHEMOURS COMPANY FC, LLC, WILMINGTON, DE (US)

(21) Appl. No.: 15/504,027

(22) PCT Filed: Sep. 14, 2015
(86) PCT No.: PCT/US15/49888

§ 371 Date: Feb. 15, 2017

Related U.S. Application Data
(60) Provisional application No. 62/050,790, filed on Sep. 16, 2014.

(51) Int. Cl. C09K 13/08; C03C 15/00

(52) U.S. Cl. CPC C09K 13/08; C03C 15/00; C03C 17/28

(57) ABSTRACT

Solutions suitable for etch cutting glass substrates are disclosed. The solutions can include: (a) about 20.1 to about 25 weight % of hydrofluoric acid; (b) about 7 to about 10.5 weight % of an organic carboxylic acid; (c) 0 to about 10 weight % of nitric acid; and (d) about 54.5 to about 72.9 weight % of water; wherein the weight % is based on the total weight of the etch cutting solution.

### FIELD OF THE INVENTION

This invention relates to a solution that can be used for etch cutting a glass substrate.

### BACKGROUND OF THE INVENTION

Toughened glass is a type of glass processed by controlled thermal or chemical treatments to increase its strength compared with normal glass. As a result of its safety and strength, toughened glass is used in a variety of demanding applications, including electronic devices, passenger vehicle windows, shower doors, architectural glass doors and tables, refrigerator trays, as a component of bulletproof glass, for diving masks, and various types of plates and cookware. Toughened glass can be engineered as a combination of thinness, lightness and impact resistance for being used as the cover glass of electronic devices including liquid crystal display, hand held device, tablet PC, mobile phone, portable media player, and laptop computer display.

The toughened glass substrate of large size must be cut into small sizes to meet the target application and cannot be reworked once toughened. Mechanical cutting is the most common way to cut toughened glass. The yield of mechanical cutting is low because toughened glass is easily broken while cutting, and there will be micro-cracks at the cutting edge of the toughened glass. Micro-cracks at the cutting edge decrease the strength of the glass and result in breakage during polishing the cutting edge or when pressure is applied on the surface.

Chemical etch cutting is a promising option to cut large size toughened glass into small panels with a portion of the glass covered with protective film, and the rest exposed to the etch cutting solution. Hydrofluoric acid (HF) is one of the chemicals currently used in chemical etching cutting of glass; however, there are some critical problems in the applications. For example, low concentrations of HF result in a slow etch rate, a sharp cutting edge (also known as an edge angle) and excessive side etch (see FIG. 1) which are not favorable for electronic device fabrication. Higher concentrations of HF result in an increase in etch rate, but also an increase of heat release and poor control of the etching process.

U.S. Patent Application 2010/0239818 discloses a method of texturizing a silicon substrate and an etching method to produce the same. The disclosed method comprising a) contacting the substrate with an etching solution comprising glycolic acid; b) etching a surface of the substrate thereby; c) forming disruption in said surface of the substrate; and d) removing the etching solution to yield a texturized substrate. The disclosed method is claimed for texturizing the silicon substrate having thickness at tens of micrometers for the manufacture of photovoltaic and electronic products, but not for cutting glass substrates having thicknesses of hundreds of micrometers.

U.S. Pat. No. 8,043,525 discloses a wet etching solution include hydrogen fluoride (0.1˜10% by weight), ammonium fluoride (0.1˜10% by weight), organic acid (30˜50% by weight), alcohol (30˜50% by weight) and water. The disclosed wet etching solution exhibits an improved oxide selectivity to metal silicide for semiconductor devices and display devices, the main purpose is to etch metal silicide and phosphorus doped silicon glass selectively, it is not suitable for cutting toughened glass.

Commonly owned Chinese Patent Application No. 103693855 discloses a method for cutting glass substrates by using a solution comprising from 10.1 to 20 weight % HF, from 5 to 20 weight % glycolic acid, from 0 to 30 weight % nitric acid, and the balance water.

In summary, while there are various methods for cutting toughened glass, there remains a need for cutting glass substrates with higher etch rate, increased edge angle and decreased side etch without excess heat generation. The present invention fills this need.

### SUMMARY OF THE INVENTION

The invention provides a glass etching solution comprising:
(a) about 20.1 weight % to about 25 weight % of hydrofluoric acid;
(b) about 7 weight % to about 10.5 weight % of an organic carboxylic acid;
(c) 0 to about 10 weight % of nitric acid; and
(d) about 54.5 weight % to about 72.9 weight % of water;

wherein the weight % is based on the total weight of the etch cutting solution, and provided that the etch cutting solution is essentially free of ammonium fluoride.

Various other features, aspects, and advantages of the present invention will become more apparent with reference to the following description, examples, and appended claims.

### DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a cross section representation of a chemically etched cut glass demonstrating side etch and edge angle.

FIG. 2 is a drawing of a partially covered glass substrate with patternized protective film.

### DETAILED DESCRIPTION OF THE INVENTION

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

As used herein, the term “produced from” is synonymous to “comprising”. As used herein, the terms “comprises,” “comprising,” “includes,” “including,” “has,” “having,” “contains” or “containing,” or any other variation thereof, are intended to cover a non to exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. If in the claim, such a phrase would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally discussed, provided that these additional materials, steps features, components, or elements do not materially affect the basic and novel characteristic(s) of the claimed invention. The term “consisting essentially of” occupies a middle ground between “comprising” and “consisting of”.

The transitional phrase “essentially no” components or “essentially free” of components, it is meant that the etch cutting solution of the invention should contain less than 1% by weight, or less than 0.1% by weight, or less than 0.01% by weight, or zero percent by weight of the component, based on the total weight of the etch cutting solution.

The term “comprising” is intended to include embodiments encompassed by the terms “consisting essentially of” and “consisting of”. Similarly, the term “consisting essentially of” is intended to include embodiments encompassed by the term “consisting of”.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “1 to 5” is recited, the recited range should be construed as including ranges “1 to 4”, “1 to 3”, “1 to 2”, “1 to 2 & 4 to 5”, “1 to 3 & 5”, and the like. Where a range of numerical values is recited herein, unless otherwise stated, the range is intended to include the endpoints thereof, and all integers and fractions within the range.

When the term “about” is used in describing a value or an end to point of a range, the disclosure should be understood to include the specific value or end to point referred to.

Further, unless expressly stated to the contrary, “or” refers to an inclusive “or” and not to an exclusive “or”. For example, a condition A “or” B is satisfied by any one of the following: A is true (or present) and B is false (or not present), A is false (or not present) and B is true (or present), and both A and B is true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

Embodiments of the present invention as described in the Detailed Description of the Invention include any other embodiments described herein, can be combined in any manner, and the descriptions of variables in the embodiments pertain to the etch cutting solutions of the present invention and method or uses thereof.

The materials, methods, and examples herein are illustrative only and, except as specifically stated, are not intended to be limiting. Although methods and materials similar or equivalent to those described herein can be used in the practice or testing of the present invention, suitable methods and materials are described herein.

The invention is described in detail herein. The invention provides a glass etch cutting solution comprising:
(a) about 20.1 weight % to about 25 weight % of hydrofluoric acid;
(b) about 7 weight % to about 10.5 weight % of an organic carboxylic acid;
(c) 0 to about 10 weight % of nitric acid; and
(d) about 54.5 weight % to about 72.9 weight % of water;

wherein the weight % is based on the total weight of the etch cutting solution, and provided that the etch cutting solution is essentially free of ammonium fluoride.

The present invention also relates to a method for cutting a glass substrate comprising:
(i) providing a glass substrate;
(ii) covering the glass substrate with a protective film;
(iii) patternizing the protective film to obtain a partially covered glass substrate, wherein the partially covered glass substrate includes a shielded area and an exposed area;
(iv) contacting the partially covered glass substrate with an etch cutting solution at about 10° C. to about 90° C. for about 1 minute to about 120 minutes;
(v) rinsing the contacted glass substrate with water;
(vi) drying the rinsed glass substrate; and
(vii) removing the protective film from the glass substrate of step (vi),
wherein the etch cutting solution of step (iv) comprises:
   (a) about 20.1 weight % to about 25 weight % of hydrofluoric acid;
   (b) about 7 weight % to about 10.5 weight % of organic carboxylic acid;
   (c) 0 to about 10 weight % of nitric acid; and
   (d) about 54.5 weight % to about 72.9 weight % of water;

wherein the weight % is based on the total weight of the etch cutting solution, and provided that the etch cutting solution is essentially free of ammonium fluoride.

Examples of glass substrates that can be cut using the glass etch cutting solution of the present invention includes the following composition: silica (SiO₂) about 55% to 79%, sodium oxide (Na₂O) 0 to about 14.2%, magnesia (MgO) about 2.5% to 7%, lime (CaO) 0 to about 10.0%, alumina (Al₂O₃) about 0.4 to 16%, boric oxide (B₂O₃) 0 to about 12%, zinc oxide (ZnO) 0 to about 1.5%, barium oxide (BaO) 0 to about 6.0% and potassium oxide (K₂O) about 12%. The glass substrate can be selected preferably from soda-lime-silica glass, silicate glass, aliminosilicate glass, fluorosilicate glass, phosphosilicate glass, boronsilicate glass, boron-phosphorus-silicate glass, ZBLAN glass, and lead glass.

The glass substrate can be toughened or tempered by methods known to those skilled in the art, such as controlled thermal or chemical treatments, as referred to H. G. Pfaender (1996) “Schott Guide to Glass”, Chapman and Hall. This glass substrate treated by toughened or tempered method is commonly referred to as toughened glass or tempered glass (herein used interchangeably). The toughened or tempered method in the present invention can be controlled thermal or chemical treatments, the processing conditions of which are known to those skilled in the art. The compressive stress on the surface of the glass is larger than 65 MPa. The present invention is also useful for etch cutting non-toughened glass.

The glass substrate can be of any shape, size, and thickness. The glass substrate can be rectangular or square. There can be single layer or multilayer of electronic components on the glass substrate. The glass substrate is preferably a flat glass plate. The glass substrate can be composed of a single layer or multilayers of glass. The thickness of the glass substrate varies depending on its application. The thickness of single layer glass plate is preferably about 300 μm to about 2000 μm, and the thickness of multilayer glass plate is preferably about 900 μm to about 6000 μm.

Prior to cutting, the glass substrate can be covered by a protective film before contacting with an etch cutting solution. Then the protective film is patternized to obtain a partially covered glass substrate, wherein the partially covered glass substrate includes a shielded area and an exposed area. The exposed areas uncovered by the protective film will be in contact with the etch cutting solution and will be cut. In most applications, the exposed areas uncovered by the protective film are smaller than the shielded areas covered by the protective film.

The protective film used in the present invention is made from polymeric materials with HF resistance. Examples of such polymeric materials for the protective films include, but are not limited to, polytetrafluoroethene (PTFE), polyimide (PI), poly(vinyl chloride) (PVC), poly(ethylene terephthalate) (PET), polypropylene (PP), perfluorosulfonic acid polymer (PFSA, also referred to as tetrafluoroethylene-perfluoro-3,6-dioxa-4-methyl-7-octene-sulfonic acid copolymer), or polyethylene (PE). The thickness of the protective film can be from about 0.01 mm to about 0.8 mm.

In one embodiment, the protective film used in the present invention is a PTFE film, for example, a PTFE film sold by E. I. du Pont de Nemours Co. under the trade name of TEFLON®.

The protective film used in the present invention can be adhered to both sides of the glass substrate through a coating process, which includes, but is not limited to, coating, laminating, or casting, etc. In addition, the protective film with adhesive on one side can be attached on both sides of the glass substrate by a laminator or by hand; the adhesive exists between the protective film and the glass substrate. Preferably, the adhesive is HF resistance, i.e. it doesn't react with HF or will not be degraded by HF. Examples of such adhesives include, but are not limited to, rubber, polyurethanes, polyacrylates, polyepoxides, or blends thereof. Preferably, the adhesive used in the present can be removed with one or more organic solvents such as methanol, ethanol, acetone, or toluene, etc.

Regardless of by coating or adhesive, the protective film should be adhered on the glass substrate tightly without any air bubbles between the protective film and the glass substrate to avoid the penetration of the etch cutting solution into the areas not intended to be etch cut.

Then the protective film is patternized to obtain a partially covered glass substrate, wherein the partially covered glass substrate includes shielded areas covered with the protective film and exposed areas to be etch cut. The protective film is patternized by cutting and removing the protective film on the exposed areas, or by a lithography process. The protective film can be cut by a knife, a roller blade, a laser cutting/engraving machine or a CNC plasma cutting machine. The exposed areas can be referred to as gaps between the shielded areas. The width of the gaps are generally at least 0.1 mm, preferably at least 0.3 mm, more preferably at least 0.5 mm. Optionally, the residue of the adhesive can be removed with one or more solvents (such as methanol, ethanol, acetone or toluene, etc.). In order to get the best cutting result, the patternized protective films, which include the shielded areas and exposed areas, are preferably symmetrical and aligned on both sides of the glass substrate.

The glass substrate used in the method of the present invention can be cut into any type of shape depending on the pattern of the patternized protective films. For example, the glass substrate can be cut into a rectangle shape, a square shape, a round shape, a curved shape and special angles (see FIG. 2). The glass substrate can be cut into any type of shape with any type of hole, e.g., a rectangle substrate with a round hole or a round substrate with a rectangle hole.

In the method of the present invention, the aforementioned partially covered glass substrate is cut apart by contacting with an etch cutting solution for a duration long enough to etch-dissolve the glass substrate of the exposed areas. The contact methods including immersing, dipping, spraying or others, are known to those skilled in the art. For instance, immersing the partially covered glass substrate into a tank containing an etch cutting solution or spraying an etch cutting solution on the partially covered glass substrate. Contacting time can be adjusted depending on the concentration of the etch cutting solution, the contacting method and the thickness of the glass substrate. Generally, the contacting time ranges from about 1 minute to about 120 minutes. The contact temperature can be increased without changing other parameters to save the contact time. Considering the boiling point of the etch cutting solution and operational safety, the contact temperature generally is from about 10° C. to about 90° C., and preferably is from room temperature to about 50° C., wherein the room temperature of the present invention may range from 15° C. to 25° C. depending on the geographic region.

In one embodiment, the contact methods used in the present invention include immersing, dipping, or spraying.

As an example of a spraying method, the partially covered glass substrate obtained according to steps described above may be placed on a roller directly; or placed on a holder with meshwork and the holder is then placed on a roller if the glass substrate is of small size (including before or after cutting). The etch cutting solution is sprayed on the partially covered glass substrate from above and below the roller with a spraying system. The temperature of the etch cutting solution is about 10° C. to about 90° C., preferably is room temperature to about 50° C. The spraying time ranges from about 1 minute to about 120 minutes.

It is common to rinse the cut glass substrate with water sufficiently for at least 0.5 minute after contacting with the etch cutting solution. The water may be deionized water. The temperature of the rinsing water can be from about 10° C. to about 90° C., preferably is from room temperature to about 50° C.

Finally, and optionally, the rinsed glass substrate is dried. The drying method used in the method of the present invention is accomplished by any means known to those skilled in the art including, for example, heat drying (oven drying), air drying, forced air drying, and fan drying. In one embodiment, the drying method used in the method of the present invention is oven drying or air drying (e.g., air knife) for at least 0.5 minute, preferably, drying by air knife for about 1 minute to about 10 minutes. The temperature for drying the glass substrate may be from about 10° C. to about 200° C. for at least 0.5 minute, preferably from room temperature to about 120° C.

After drying, the protective film can be removed by hand or by stripper solution from the cut glass substrate. The residue of the adhesive if needed can be removed with one or more solvents such as methanol, ethanol, acetone or toluene, etc.

The resultant cut glass of the present invention does not exhibit micro-cracking, as exhibited on the glass cut by mechanical cutting devices. In addition, the resultant glass has decreased side etch and increased edge angle when compared to the glass etch cut with an etching solutions of the prior art.

The etch cutting solution of the present invention is prepared by combining hydrofluoric acid, an organic carboxylic acid, optionally nitric acid and water. The etch cutting solution comprises:
(a) about 20.1 weight % to about 25 weight % of hydrofluoric acid;
(b) about 7 weight % to about 10.5 weight % of an organic carboxylic acid;
(c) 0 to about 10 weight % of nitric acid; and
(d) about 54.5 weight % to about 72.9 weight % of water;

wherein the weight % is based on the total weight of the etch cutting solution, and provided that the etch cutting solution is essentially free of ammonium fluoride.

Any suitable organic carboxylic acid may be used; however, preferred organic carboxylic acids comprise alpha-hydroxyl-acids, and preferably citric acid or glycolic acid, with glycolic acid being particularly preferred. Other suitable organic carboxylic acids comprise materials selected from oxalate acid, lactic acid, and propanedioic acid.

Hydrofluoric acid (HF), CAS number: 7664-39-3, is commercially available as aqueous solution, e.g., 40% or 49% by weight in water, and can be purchased from ECHO Chemical Co. Ltd. (Taiwan) or Sinopharm Chemical Reagent Co. Ltd. (China).

In the etch cutting solution of the present invention, the amount of HF is about 20.1 weight % to about 25 weight %, preferably about 20.2 weight % to about 23 weight %, wherein the weight % is based on the total weight of the etch cutting solution.

Glycolic acid (GA), CAS number: 79-14-1, may be a chemical of 98% or higher in purity or its aqueous solution, e.g., GA aqueous solution sold by E. I. du Pont de Nemours and Company, Wilmington, Del., USA.

In the etch cutting solution of the present invention, the amount of the organic carboxylic acid, and preferably glycolic acid, is about 7 weight % to about 10.5 weight %, preferably about 10.5 weight %, wherein the weight % is based on the total weight of the etch cutting solution.

Nitric acid (HNO₃), CAS number: 7697-37-2, may be fuming nitric acid of high purity or its aqueous solution, e.g., aqueous solution with 70 weight % of nitric acid, and can be purchased from ECHO Chemical Co. Ltd. (Taiwan) or Sinopharm Chemical Reagent Co. Ltd. (China).

In the etch cutting solution of the present invention, the amount of the nitric acid is from 0 weight % to about 10 weight %, preferably about 5 weight %, wherein the weight % is based on the total weight of the etch cutting solution.

All the chemicals and their aqueous solutions used in the etch cutting solutions of the present invention are commercially available. When preparing the etch cutting solution, the order of addition of the acid components is not critical, but for safety concern, the acid components should be added to the water (d).

In one embodiment, the amounts of the acids in the etch cutting solution of the present invention are as follows: hydrofluoric acid at about 20.1 weight % to about 25 weight %, glycolic acid at about 7 weight % to about 10.5 weight %, and nitric acid at 0 to about 10 weight %.

In a second embodiment, the amounts of the acids in the etch cutting solution that can be used in the method of the present invention are as follows: hydrofluoric acid at about 20.2 weight % to about 23 weight %, glycolic acid at about 7 weight % to about 10.5 weight %, and nitric acid at 0 weight % to about 10 weight %.

In a third embodiment, the amounts of the acids in the etch cutting solution that can be used in the method of the present invention are as follows: hydrofluoric acid at about 20.2 weight % to about 23 weight %, and glycolic acid at about 10.5 weight %, and nitric acid at about 5 weight %.

Weight percentage of acid components described herein, e.g., hydrofluoric acid, glycolic acid, and nitric acid, refers to pure acid and not to aqueous amounts of the acid components. Further, weight percentage of water (d) in the etch cutting solution of the present invention refers to water added as a remainder to balance the total weight percentage of the etch cutting solution, plus any water included in other components (a)-(c) of the etch cutting solution (e.g., aqueous hydrofluoric acid, aqueous glycolic acid and aqueous nitric acid). In all of the embodiments as defined above, the etch cutting solution is essentially free of ammonium fluoride.

The glass substrates produced in the method of the present invention are useful as the cover glass of electronic devices including liquid crystal display, hand held device, tablet PC, mobile phone, portable media player, and laptop computer display.

The present invention provides a method for cutting a glass substrate without micro-cracks, as exhibited on the glass cut through mechanical cutting devices. The glass substrates cut with a method of the present invention have three main benefits compared to glass substrates cut with the etch cutting solutions of the prior art. First, the method of the present invention has an increased etch rate without a significant increase of heat release and poor control of the etching process. Second, the method of the present invention results in a glass substrate with decreased side etch. Third, the method of the results in a glass substrate with increased edge angle.

### EXAMPLES

### Test Methods and Materials

### Materials Used in Examples 1-3 and Comparative Examples 1-4

Glass substrate: toughened soda-lime glass and toughened aluminosilicate glass.

Hydrofluoric acid (HF): CAS number: 7664-39-3, 49% by weight, purchased from ECHO Chemical Co. Ltd., Taiwan.

Glycolic acid (GA): CAS number: 79-14-1, aqueous solution available from The Chemours Company, Wilmington, Del., USA.

Nitric acid: CAS number: 7697-37-2, aqueous solution with 70 weight % of nitric acid, purchased from: ECHO Chemical Co. Ltd. (China).

The protective film was a polytetrafluoroethene (PTFE) tape with acrylics adhesive on one side. Thickness of the tape is 0.1 mm, purchased from 3M, St. Paul, Minn., USA.

### Preparation of the Etch Cutting Solutions

Seven etch cutting solutions (Comparative Examples 1, 2, 3, and 4 and Examples 1, 2, and 3) were prepared by mixing hydrofluoric acid, glycolic acid, nitric acid and water. Compositions of the etch cutting solutions are listed in Table 1 by weight percent of each of hydrofluoric acid, glycolic acid, and nitric acid in the final solution, with the balance being water.

TABLE 1

| Example # | HF | Glycolic Acid | Nitric Acid |
|---|---|---|---|
| Comparative | 17.9% | 7% | 3.5% |
| Example 1 | | | |
| Comparative | 20% | 3.5% | 14.2% |
| Example 2 | | | |
| Comparative | 22.0% | 0% | 0% |
| Example 3 | | | |
| Comparative | 18.4% | 0% | 3.5% |
| Example 4 | | | |
| Example 1 | 20.2% | 10.5% | 5% |
| Example 2 | 23% | 10.5% | 5% |
| Example 3 | 21% | 10.5% | 5% |

### Test Method 1: Etch Rate Test Procedure—Spraying

The glass substrate was put on the roller of a spraying system directly. The etch cutting solutions from each Example and Comparative Example were sprayed onto the glass substrate from above and below the roller with the spraying system. The temperature of the etch cutting solutions was about 35° C. The incompletely cut glass substrate was taken out after contacting for about 20 minutes, and then was rinsed with deionized water sufficiently for at least about 0.5 minute. The temperature of the rinse water was about 35° C. The rinsed glass was dried by air knife for about 5 minutes. The temperature of the drying air was about 70° C.

The thickness of each glass substrate was measured by a micrometer to determine the thickness difference with respect to the respective initial thickness. The thickness difference was converted to an etch rate expressed in μm/min and listed in Tables 2 and 3.

TABLE 2
Etching rate with aluminoslicate glass

| Example # | Both Sides (μm/min) |
|---|---|
| Comparative | 26.3 |
| Example 1 | |
| Comparative | 38.4 |
| Example 2 | |
| Comparative | 35.6 |
| Example 3 | |
| Comparative | 26.0 |
| Example 4 | |
| Example 1 | 34.6 |
| Example 2 | 41.9 |
| Example 3 | 34.1 |

TABLE 3
Etching rate with Soda-lime glass

| Example # | Both Sides (μm/min) |
|---|---|
| Comparative | 17.7 |
| Example 1 | |
| Comparative | 24.7 |
| Example 2 | |
| Comparative | 24.4 |
| Example 3 | |
| Comparative | 16.7 |
| Example 4 | |
| Example 1 | 23.2 |
| Example 2 | 28.9 |
| Example 3 | 24.7 |

### Test Method 2: Side Etch and Edge Angle Measurement

Both sides of the glass substrate were covered by PTFE protective films with acrylic adhesive on one side by a laminator before contacting with the etch cutting solution. The protective films were cut with laser to form a pattern. The pattern of the protective film was symmetrical and aligned on both sides. The protective films on the exposed areas were peeled off manually and the areas to be etched were exposed. All the residue of adhesive on the exposed areas were removed with ethanol. In all Examples and Comparative Examples, the partially covered glass substrate obtained after patternizing had two gaps of different width—1.5 mm and 0.9 mm (See pattern A in FIG. 2).

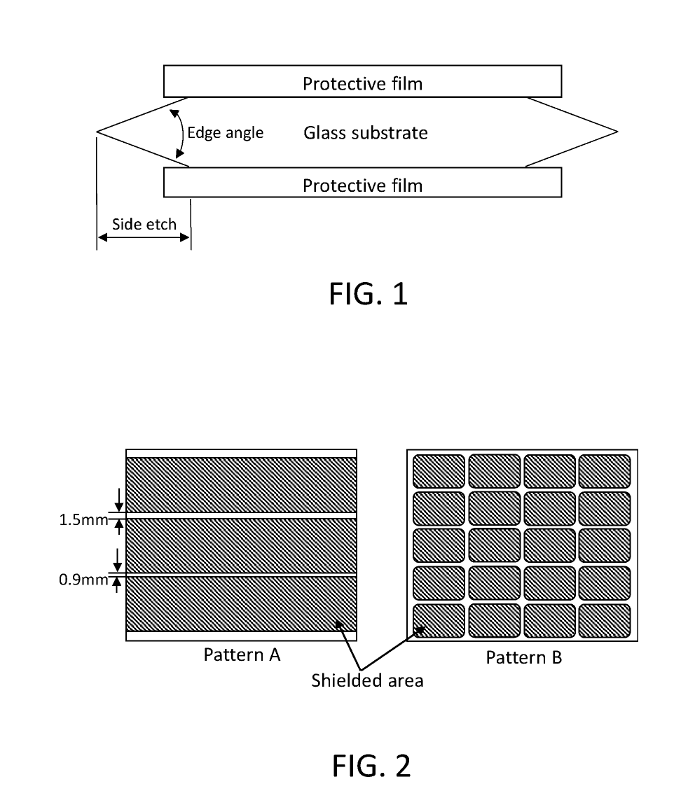

The partially covered glass substrate was placed on a roller. For each of Comparative Examples 1 and 2, and Examples 1, 2, and 3, a number of test runs were completed (see Tables 4 and 5). Tables 4 and 5 report the average Etching gap and Side etch for each Example and Comparative Example. The edge angle is the angle measurement of the etched surface compared to the un-etched surface. The side etch is the measurement of the distance from the edge of the exposed substrate (i.e. the vertex from the side view) to the edge of the unexposed substrate. If the side etches of the two sides are different, the larger value is reported as the side etch (see FIG. 1).

For each test run the etch cutting solution was sprayed on the glass substrate from above and below the roller with a spraying system. The temperature of the etch cutting solution was about 35° C. The glass substrate after cutting was rinsed with deionized water sufficiently for about 0.5 minute. The temperature of the rinse water was about 35° C. The rinsed glass substrate was dried by air knife for about 2 minutes. The temperature of the drying air was about 70° C. The etch time was adjusted to cut apart the glass substrate according to the etch rate determined by Test Method 1.

An image of the cross-section of the cut glass substrate was taken by Microscope (Olympus, model number: BX-RLA2, software: image measurement tool) to measure and record the side etch and etch angle and listed in Tables 4 and 5. Results are reported in Tables 4 and 5 below.

TABLE 4

| | | Etching | | |
|---|---|---|---|---|
| | | gap | Side etch | Edge angle |
| Example # | Glass type | (mm) | (μm) | (degrees) |
| Comparative | ALUMINOSILICATE | 0.9 | 400.5 | 58.609 |
| Example 1 | GLASS | | | |
| | (8 test runs) | | | |
| | SODALIME SILICA | 0.9 | 445.5 | 26.764 |
| | GLASS | | | |
| | (4 test runs) | | | |
| Comparative | ALUMINOSILICATE | 0.9 | 453.5 | 45.446 |
| Example 2 | GLASS | | | |
| | (8 test runs) | | | |
| | SODALIME SILICA | 0.9 | 235.25 | 75.402 |
| | GLASS | | | |
| | (4 test runs) | | | |
| Comparative | ALUMINOSILICATE | 0.9 | 556.75 | 26.822 |
| Example 3 | GLASS | | | |
| | (8 test runs) | | | |
| | SODALIME SILICA | 0.9 | 677 | 81.915 |
| | GLASS | | | |
| | (4 test runs) | | | |
| Comparative | ALUMINOSILICATE | 0.9 | 669.375 | 19.425 |
| Example 4 | GLASS | | | |
| | (8 test runs) | | | |
| | SODALIME SILICA | 0.9 | 416.75 | 65.218 |
| | GLASS | | | |
| | (4 test runs) | | | |
| Example 1 | ALUMINOSILICATE | 0.9 | 332 | 92.602 |
| | GLASS | | | |
| | (8 test runs) | | | |
| | SODALIME SILICA | 0.9 | 170.75 | 102.815 |
| | GLASS | | | |
| | (4 test runs) | | | |
| Example 2 | ALUMINOSILICATE | 0.9 | 415.308 | 131.549 |
| | GLASS | | | |
| | (13 test runs) | | | |
| | SODALIME SILICA | 0.9 | 155.5 | 132.977 |
| | GLASS | | | |
| | (6 test runs) | | | |
| Example 3 | ALUMINOSILICATE | 0.9 | 259.375 | 106.435 |
| | GLASS | | | |
| | (8 test runs) | | | |
| | SODALIME SILICA | 0.9 | 126.5 | 120.835 |
| | GLASS | | | |
| | (4 test runs) | | | |

TABLE 5

| | | Etching | | |
|---|---|---|---|---|
| | | gap | Side etch | Edge angle |
| Example # | Glass type | (mm) | (μm) | (degrees) |
| Comparative | ALUMINOSILICATE | 1.5 | 457.25 | 53.592 |
| Example 1 | GLASS | | | |
| | (8 test runs) | | | |
| | SODALIME SILICA | 1.5 | 484.75 | 27.026 |
| | GLASS | | | |
| | (4 test runs) | | | |
| Comparative | ALUMINOSILICATE | 1.5 | 643.25 | 23.843 |
| Example 2 | GLASS | | | |
| | (8 test runs) | | | |
| | SODALIME SILICA | 1.5 | 240 | 75.881 |
| | GLASS | | | |
| | (4 test runs) | | | |
| Comparative | ALUMINOSILICATE | 1.5 | 619.25 | 16.517 |
| Example 3 | GLASS | | | |
| | (8 test runs) | | | |
| | SODALIME SILICA | 1.5 | 575 | 79.943 |
| | GLASS | | | |
| | (4 test runs) | | | |
| Comparative | ALUMINOSILICATE | 1.5 | 760.571 | 16.141 |
| Example 4 | GLASS | | | |
| | (7 test runs) | | | |
| | SODALIME SILICA | 1.5 | 380.25 | 59.504 |
| | GLASS | | | |
| | (4 test runs) | | | |
| Example 1 | ALUMINOSILICATE | 1.5 | 394.286 | 75.75 |
| | GLASS | | | |
| | (7 test runs) | | | |
| | SODALIME SILICA | 1.5 | 211.25 | 95.221 |
| | GLASS | | | |
| | (4 test runs) | | | |
| Example 2 | ALUMINOSILICATE | 1.5 | 352.25 | 91.733 |
| | GLASS | | | |
| | (20 test runs) | | | |
| | SODALIME SILICA | 1.5 | 147.1 | 126.631 |
| | GLASS | | | |
| | (10 test runs) | | | |
| Example 3 | ALUMINOSILICATE | 1.5 | 232.875 | 102.602 |
| | GLASS | | | |
| | (8 test runs) | | | |
| | SODALIME SILICA | 1.5 | 131.25 | 116.265 |
| | GLASS | | | |
| | (4 test runs) | | | |

While the invention has been illustrated and described in typical embodiments, it is not intended to be limited to the details shown, since various modifications and substitutions are possible without departing from the spirit of the present invention. As such, modifications and equivalents of the invention herein disclosed may occur to persons skilled in the art using no more than routine experimentation, and all such modifications and equivalents are believed to be within the spirit and scope of the invention as defined by the following claims.

### Materials Used in Examples 4-7

Hydrofloric acid (HF): CAS number 7664-39-3, 49% purchased from Honeywell
Glycolic Acid (GA): CAS number 79-14-1, 70% purchased from The Chemours Company
Nitric acid (NA): CAS number 7697-37-2, 67%
Citric acid (CA): CAS number 5949-29-1, 99% EMD Millipore
Oxalic acid (OA): CAS number 6153-56-6, 99.8% purchased form EMD Millipore
Lactic acid (LA): CAS number 7732-18-5, 88% purchased from Acros Organics

### Preparation of the Etch Cutting Solutions

Compositions of the etch cutting solutions are listed in Table 6 by weight percent of each of hydrofluoric acid, glycolic acid, and nitric acid, citric acid, oxalic acid and lactic acid in the final solution, with the balance being water.

TABLE 6

| | | Organic Carboxylic | |
|---|---|---|---|
| Example # | HF | Acid | Nitric Acid |
| Example 4 | 25% | GA: 20% | 5% |
| Example 5 | 20.1% | CA: 12% | 4% |
| Example 6 | 20.1% | OA: 10.5% | 4% |
| Example 7 | 20.1% | LA: 10.5% | 4% |

### Test Method 1: Etch Rate Test Procedure—Spraying

The glass substrate was put on the roller of a spraying system directly. The etch cutting solutions from each Example were sprayed onto the glass substrate from above and below the roller with the spraying system. The temperature of the etch cutting solutions was about 30° C. The incompletely cut glass substrate was taken out after contacting for about 20 minutes, and then was rinsed with deionized water sufficiently for at least about 0.5 minute. The temperature of the rinse water was about 30° C. The rinsed glass was dried by air knife for about 5 minutes. The temperature of the drying air was about 70° C.

The thickness of each glass substrate was measured by a micrometer to determine the thickness difference with respect to the respective initial thickness. The thickness difference was converted to an etch rate expressed in μm/min and listed in Tables 7.

TABLE 7
Etching rate with aluminoslicate glass

| Example # | Both Sides (μm/min) |
|---|---|
| Example 4 | 89.85 |
| Example 5 | 42.4 |
| Example 6 | 34.6 |
| Example 7 | 41.9 |

### Test Method 2: Side Etch and Edge Angle Measurement

Both sides of the glass substrate were covered by PTFE protective films with acrylic adhesive on one side by a laminator before contacting with the etch cutting solution. The protective films were cut with laser to form a pattern. The pattern of the protective film was symmetrical and aligned on both sides. The protective films on the exposed areas were peeled off manually and the areas to be etched were exposed. All the residue of adhesive on the exposed areas were removed with ethanol. In all Examples the partially covered glass substrate obtained after patternizing had two gaps of different width—1.5 mm and 0.9 mm (See pattern A in FIG. 2).

The partially covered glass substrate was placed on a roller. For each of Examples 4 to 7 and a number of test runs were completed (see Table 8). Table 8 reports the average Etching gap and Side etch for each Example. The edge angle is the angle formed from the of the etched surface compared to the un-etched surface. The side etch is the measurement of the distance from the edge of the exposed substrate (i.e. the vertex from the side view) to the edge of the unexposed substrate. If the side etches of the two sides are different, the larger value is reported as the side etch (see FIG. 1).

For each test run the etch cutting solution was sprayed on the glass substrate from above and below the roller with a spraying system. The temperature of the etch cutting solution was about 30° C. The glass substrate after cutting was rinsed with deionized water sufficiently for about 0.5 minute. The temperature of the rinse water was about 30° C. The rinsed glass substrate was dried by air knife for about 2 minutes. The temperature of the drying air was about 70° C. The etch time was adjusted to cut apart the glass substrate according to the etch rate determined by Test Method 1.

An image of the cross-section of the cut glass substrate was taken by Microscope (Olympus, model number: BX-RLA2, software: image measurement tool) to measure and record the side etch and etch angle and listed in Tables 8.

TABLE 8

| | | | | Edge |
|---|---|---|---|---|
| | | Etching gap | Side etch | angle |
| Example # | Glass type | (mm) | (μm) | (degrees) |
| Example 4 | ALUMINOSILICATE | 1.0 | 249 | 118 |
| | GLASS | | | |
| Example 5 | ALUMINOSILICATE | 1.0 | 267 | 130 |
| | GLASS | | | |
| Example 6 | ALUMINOSILICATE | 1.0 | 327 | 108 |
| | GLASS | | | |
| Example 7 | ALUMINOSILICATE | 1.0 | 278 | 92 |
| | GLASS | | | |

It can be seen in examples 4 through 7 that the reduced side etch and improved edge angle makes the use of organic carboxylic acid of great utility. The etching cutting is greatly improve even at high concentrations of HF with etch rates of 90 microns per minute.

What is claimed is:

1. An etch cutting solution comprising:
(a) about 20.1 weight % to about 25 weight % of hydrofluoric acid;
(b) about 7 weight % to about 10.5 weight % of an organic carboxylic acid;
(c) 0 to about 10 weight % of nitric acid; and
(d) about 54.5 weight % to about 72.9 weight % of water;
wherein the weight % is based on the total weight of the etch cutting solution, and provided that the etch cutting solution is essentially free of ammonium fluoride.

2. The etch cutting solution of claim 1, wherein the etch cutting solution comprises about 20.2 weight % to about 23 weight % of the hydrofluoric acid.

3. The etch cutting solution claim 1, wherein the etch cutting solution comprises about 10.5 weight % of the organic carboxylic acid.

4. The etch cutting solution of claim 1, wherein the etch cutting solution comprises about 5 weight % of the nitric acid.

5. The etch cutting solution of claim 1, wherein the organic carboxylic acid comprises an alpha-hydroxy-acid.

6. The etch cutting solution of claim 5, wherein the alpha-hydroxy-acid comprises a material selected from the group consisting of citric acid and glycolic acid.

7. The etch cutting solution of claim 6, wherein the alpha-hydroxy-acid comprises glycolic acid.

8. The etch cutting solution of claim 1, wherein the organic carboxylic acid comprises a material selected from the group consisting of oxalate acid, citric acid, propaneioic acid, lactic acid, and glycolic acid.

9. An etch cutting solution comprising:
(a) about 20.1 weight % to about 25 weight % of hydrofluoric acid;
(b) about 7 weight % to about 10.5 weight % of glycolic acid;
(c) 0 to about 10 weight % of nitric acid; and
(d) about 54.5 weight % to about 72.9 weight % of water;
wherein the weight % is based on the total weight of the etch cutting solution.

10. The etch cutting solution of claim 9, wherein the etch cutting solution comprises about 20.2 weight % to about 23 weight % of the hydrofluoric acid.

11. The etch cutting solution of claim 9, wherein the etch cutting solution comprises about 10.5 weight % of the glycolic acid.

12. The etch cutting solution of claim 9, wherein the etch cutting solution comprises about 5 weight % of the nitric acid.
